(19) United States
(12) Patent Application Publication
(10) Pub. No.: US 2014/0129274 A1
(43) Pub. Date: May 8, 2014

(54) SECURITY ESCORT ASSIGNMENT AND MONITORING SYSTEM AND METHOD

(71) Applicant: POSITION LOGIC LLC, Naples, FL (US)

(72) Inventors: Felix Lluberes, Naples, FL (US); Hong Long, Naples, FL (US)

(73) Assignee: POSITION LOGIC LLC, Naples, FL (US)

(21) Appl. No.: 13/670,771

(22) Filed: Nov. 7, 2012

(51) Int. Cl. G06Q 10/06

(52) U.S. Cl. 705/7.15

(57) ABSTRACT

Systems and methods providing security escort assignment and monitoring. Embodiments of the invention allow a user (e.g., a security dispatcher) to plan a mission, assign assets to the mission, and monitor a virtual representation of the mission as the mission proceeds in the real world.

### BACKGROUND

1. Technical Field

The subject matter disclosed herein relates to security. In particular, the subject matter disclosed herein relates to security escort assignment and monitoring.

2. Discussion of Art

Security companies that are in the business of transporting valuable assets may have several security vehicles accompany a main transport vehicle as part of a delivery mission. A plan may be established, before the mission takes place, that is to be followed by the security vehicles and the main transport vehicle. However, once the mission starts, the ability for a dispatcher to stay aware of the status of the mission and to know whether or not the vehicles in the mission are adhering to the mission plan may be very limited.

### BRIEF DESCRIPTION

In one embodiment, a system is provided that includes a controller operable to allow a user to plan and monitor a mission by providing selectable options to a user for assigning escort assets to one or more target assets, assigning characteristics and properties to the assets, assigning a formation to the assets, and assigning a route for the formation of the assets to travel along during a mission. The assigned characteristics may include one or more of asset type, asset identification, and asset duty or responsibility (e.g., lead escort vehicle). The assigned properties may include one or more of a maximum allowed distance of an asset from another asset in the formation, an allowed position of an asset relative to another asset in the formation, and a maximum allowed speed of an asset. A mission plan may include one or more stopping operations for the pick-up or the drop-off of goods or personnel. The controller may further be operable to provide selectable options to a user for assigning one or more formations to the assets that the assets are to assume when the assets are performing the one or more stopping operations. The controller is further operable to generate an alert when an asset deviates from an assigned property, formation, or route during the mission. The controller may also be operable to generate an event when an asset adheres to or completes an aspect of the mission. The controller may further be operable to facilitate a virtual representation of the assets, the characteristics and properties of the assets, generated alerts or events, and the route to assist the user in monitoring the assets in real time as the assets travel along the route during the mission. The system may also include one or more tracking devices associated with the assets and operable to track and report the positions of the assets to the controller in real time. The system may further include a data communication infrastructure operable to facilitate communication between the controller and the one or more tracking devices. The controller may include a display screen and a user interface to allow a user to at least select the selectable options and view the virtual representations. Alternatively, the system may include a user device, having a display screen and a user interface, operable to communicate with the controller to allow a user to at least select the selectable options and view the virtual representations. The controller may be operable to generate one or more reports with respect to one or more of the assets, with respect to the route as traveled by the assets, or with respect to completion of the mission or one or more aspects of the mission.

In one embodiment, a non-transitory computer readable medium is provided having computer executable instructions of a software application recorded thereon. The computer executable instructions are configured to be executed by a processor of a controller to provide security escort assignment and monitoring. The instructions may include instructions providing selectable options to a user for: assigning escort assets to one or more target assets, assigning characteristics and properties to the assets, assigning a formation to the assets, and assigning a route for the formation of the assets to travel along during a mission. The instructions may further include instructions to facilitate the virtual representation of: the route, the assets on the route, and the characteristics and properties of the assets to assist in monitoring the assets in real time as the assets travel in formation along the route during the mission. The instructions may also include instructions for generating an alert when an asset deviates from an assigned property, formation, or route during the mission. The instructions may further include instructions for generating an event when an asset adheres to or completes an aspect of the mission. The assigned formation may be different depending on the location of the assets along the route. The instructions may also include instructions for generating one or more reports with respect to one or more of the assets, with respect to the route as traveled by the assets, or with respect to completion of the mission or one or more aspects of the mission.

In one embodiment, a computerized method is provided. The method includes assigning escort assets to one or more target assets, assigning characteristics and properties to the assets, assigning a formation to the assets, and assigning a route for the formation of the assets to travel along during a mission. The method may also include tracking at least a position of each of the assets during the mission. The method may further include generating an alert when an asset deviates from an assigned property, formation, or route during the mission. The method may also include generating an event when an asset adheres to or completes an aspect of the mission. The method may also include virtually representing and displaying the assets, the characteristics and properties of the assets, the generated alert or event, and the route to assist in monitoring the assets in real time as the assets travel along the route during the mission. The method may further include generating one or more reports with respect to one or more of the assets, with respect to the route as traveled by the assets, or with respect to completion of the mission or one or more aspects of the mission.

### BRIEF DESCRIPTION OF THE DRAWINGS

Reference is made to the accompanying drawings in which particular embodiments of the invention are illustrated as described in more detail in the description below, in which:

FIG. 1 is a schematic block diagram of an exemplary embodiment of a system for providing security escort assignment and monitoring;

FIG. 2 is a flowchart of an embodiment of a method for providing security escort assignment and monitoring using the system of FIG. 1;

FIG. 3 illustrates an exemplary embodiment of a representation of an assigned formation of escort assets and a target asset configured using the system of FIG. 1;

FIG. 4 illustrates an exemplary embodiment of a screen shot of a map view provided by the system of FIG. 1 showing a virtual representation of a route of a planned mission;

FIG. 5 illustrates an exemplary embodiment of a screen shot of a zoomed-in portion of the map view of FIG. 4 showing a virtual representation of the formation of assets of FIG. 3 at a location along the route of FIG. 4 during the mission; and

FIG. 6 illustrates a satellite view of the zoomed-in portion of FIG. 5 showing a virtual representation of the formation of assets of FIG. 3 at a location along the route of FIG. 4 during the mission.

### DETAILED DESCRIPTION

Embodiments of the invention relate to methods and systems providing security escort assignment and monitoring capabilities. Security companies are concerned with transporting valuable assets and/or personnel, and providing security vehicles to escort the assets or personnel along a planned route during a mission. A security company may desire to keep track of the assets and/or personnel, and the escorts, in real time during the mission. Embodiments of the invention may allow a user (e.g., a security dispatcher) to plan a mission, assign assets to the mission, and monitor a virtual representation of the mission as the mission proceeds in the real world to, for example, track the efficiency of the escort team and become aware of any problems that arise during the mission.

“Software” or “computer program” as used herein includes, but is not limited to, one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Computer” or “processing element” or “computer device” or “processor” as used herein includes, but is not limited to, any programmed or programmable electronic device that can store, retrieve, and process data. “Non-transitory computer-readable media” include, but are not limited to, a CD-ROM, a removable flash memory card, a hard disk drive, a magnetic tape, and a floppy disk. “Computer memory”, as used herein, refers to a storage device configured to store digital data or information which can be retrieved by a computer or processing element. “Controller”, as used herein, refers to the logic circuitry and/or processing elements and associated software or program involved in providing security escort and monitoring. The terms “signal”, “data”, and “information” may be used interchangeably herein and may refer to digital or analog forms. The term “communication device” as used herein may refer to any wired or wireless device (e.g., a computer modem) operable to receive and/or transmit signals, data, or information. The term “virtual” as used herein refers to the simulation and representation of real world objects, characteristics, and actions in a computer environment.

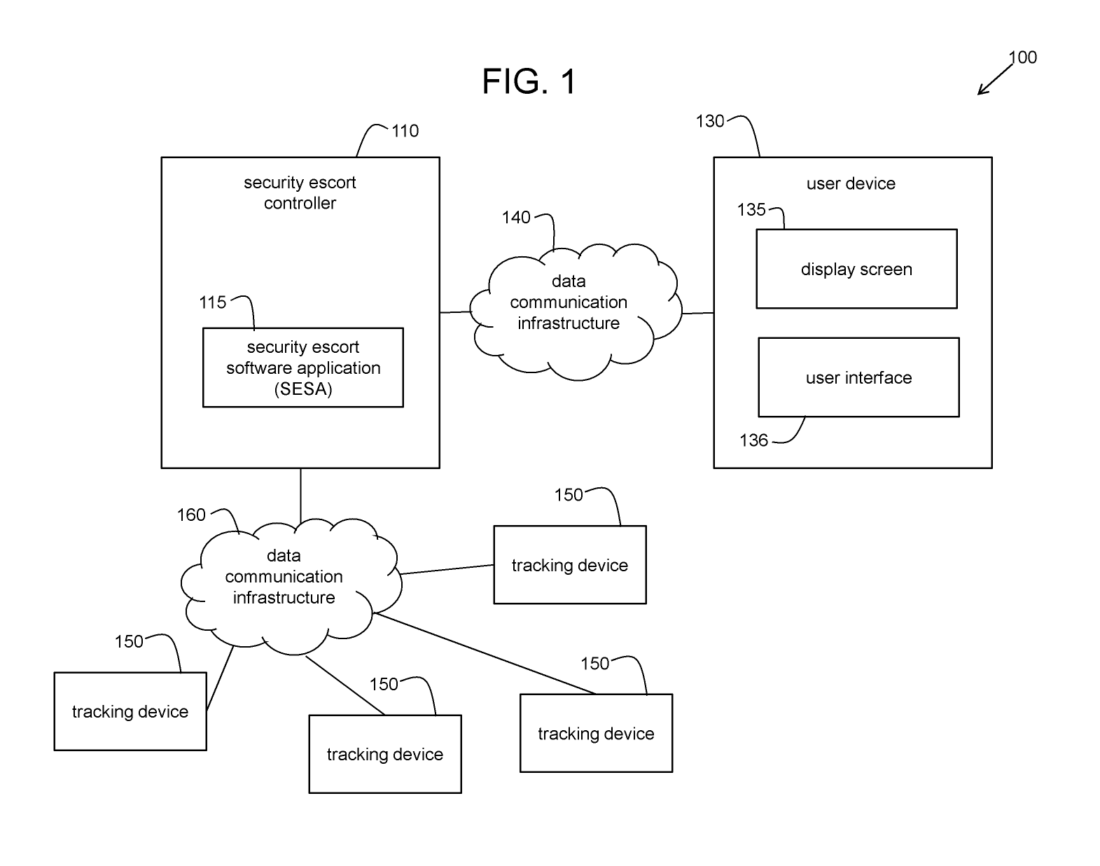

FIG. 1 is a schematic block diagram of an exemplary embodiment of a system 100 for providing security escort assignment and monitoring. The system 100 provides virtual representations of escort assets, target assets, and routes that may be visually and graphically displayed and monitored. An escort asset may be a vehicle such as, for example, a motorcycle, a car, or a truck operated by a person on-board the vehicle (or possibly operated remotely). A target asset may be, for example, a transport vehicle operated by a person on board the vehicle (or possibly operated remotely) and carrying cargo and/or personnel that is to be protected by the escort assets along a route during a mission.

The system 100 includes a security escort controller 110 operable to provide security escort assignment and monitoring by allowing a user to plan and monitor a mission via selectable options. The controller 110 is operable to facilitate the virtual representation of assigned escort assets, assigned target assets, and an assigned route of a mission, along with characteristics and properties of the assets. Selectable options may be provided to a user, through a graphical interface, for assigning escort assets to one or more target assets, assigning characteristics and properties to the assets, assigning a formation to the assets, and assigning a route for the formation of the assets to travel along during the mission as a convoy.

In accordance with an embodiment, the security escort controller 110 is implemented as a server computer 110 running a security escort software application (SESA) 115. The controller 110 may include one or more processing elements (e.g., microprocessors) for executing the software application 115. The controller 110 allows mission planning and monitoring (e.g., the assignment and tracking of escort assets and target assets) and provides a graphical mapping that allows visualization of a virtual representation of the mission by a user on a display screen. In accordance with an embodiment, the security escort software application may be recorded on a non-transitory computer-readable medium for distribution, for example.

The system 100 also includes a user device 130 (e.g., a desktop personal computer, a hand-held tablet computer, or a mobile telephone) having a user interface including a display screen 135 (e.g., a touchscreen display) and, optionally, a keyboard and/or a mouse 136. The user device also includes a processing element (not shown) and is configured to communicate with the security escort controller 110 either directly or via a data communication infrastructure 140 (e.g., a computer network). The user device may be located in an office on site at a facility of a security dispatch company, or may be remotely located away from the facility. In accordance with an embodiment, the user device may be a mobile, wireless, touch-screen, hand-held device, for example, operated by a user while traveling from one facility to another. In accordance with an alternative embodiment, the controller and the user device are integrated into a single device having a display screen and a user interface.

The system 100 also includes tracking devices 150 associated with the assets and being in operative communication with the security escort controller 110 via, for example, a data communication infrastructure 160 (e.g., a cellular telephone network, a satellite communication network, and/or the internet). The tracking devices 150 are configured to track the position (e.g., absolute position) of each of the assets and/or the relative position of the assets with respect to each other and report (communicate) the positions to the controller. In accordance with an embodiment, each escort asset and target asset has a global positioning system (GPS) transceiver on board (e.g., in the form of a cellular telephone) that tracks the location of the asset.

The location of an asset (e.g., in the form of GPS coordinates) may be wirelessly communicated to a cellular telephone system (e.g., part of the data communication infrastructure 160) and then communicated from the cellular telephone system to the internet (another part of the data communication infrastructure 160) and to the controller 110. The controller 110 may receive the location of each of the assets and display the assets at the locations on a map as the assets travel along a route of a planned mission. In accordance with other embodiments, other types of tracking devices and methods of communicating asset location information to the controller 110 may be implemented, without departing from the scope of the present application. In accordance with an embodiment, associated asset identification information may be provided to the controller along with the position information. Other associated information may be provided as well, in accordance with various embodiments.

In accordance with various other embodiments, the system may be configured in various other ways. For example, if the controller is on site at a security dispatch facility, the user device may communicate in a direct wired manner with the controller, or via a data communication infrastructure 140 which may be a local area network. If the controller is remotely located from the security dispatch facility, then communication with the user device may be via the internet. For example, the controller may be hosted at a third party site (e.g., a provider of the SESA) as a software-as-a-service (SaaS) configuration. As a further example, the data communication infrastructures 140 and 160 may be the same network (e.g., a satellite network). Other configurations are possible as well, in accordance with various other embodiments of the present invention, without departing from the scope of the present application.

As an example, assets (escort vehicles and target vehicles) may be located at a facility of a security company awaiting assignment to a mission. In accordance with an embodiment, the system 100 provides a graphical interface that is displayed on a display screen 135 of the user device allowing a user to plan a mission by assigning assets as discussed below herein. A user can interact with the security escort controller via the user interface device to virtually configure the formation of the assets and the route the assets are to travel during the mission. The assigned formation and route may reflect the type of mission and/or the expected security threats. In accordance with an embodiment, the assigned formation may change, depending on the location of the assets along the route of the mission.

A user can interact with the security escort controller via the user device to view the location of the assets during a mission, check the status of the assets with respect to assigned characteristics or properties, review and react to alerts, and review upcoming or completed mission events or milestones as discussed below herein. Checking the status of an asset may involve, for example, checking the identity of an escort vehicle and/or a target vehicle, checking an assigned characteristic or property of an escort vehicle or a target vehicle, checking a current location of the convoy of vehicles, and checking the assigned destination of the convoy of vehicles.

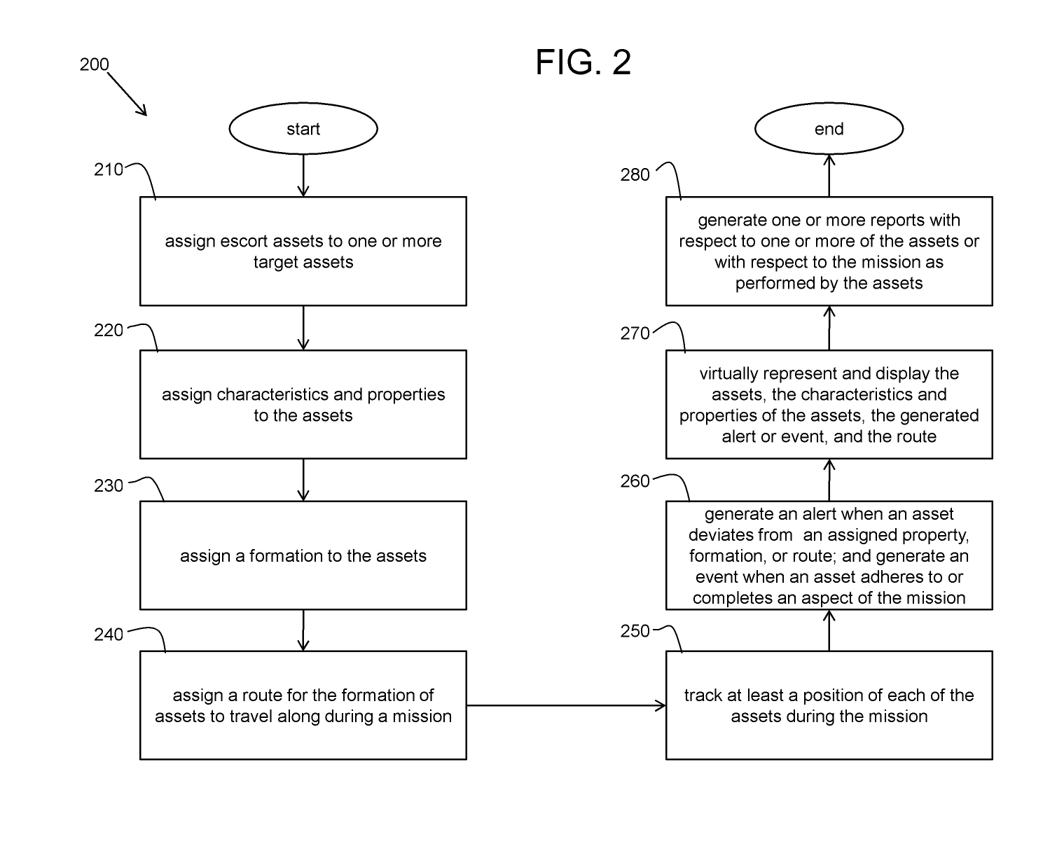

FIG. 2 is a flowchart of an embodiment of a method 200 for providing security escort assignment and monitoring using the system 100 of FIG. 1. In step 210 of the method 200, a user may assign one or more escort assets to one or more target assets to form a convoy for a mission. A list of selectable escort vehicles may be provided by the controller and displayed to the dispatcher on the user device. Similarly, a list of selectable target vehicles may be provided by the controller and displayed to the dispatcher on the user device. In step 220, the user may assign characteristics and properties to the assets. In step 230, the user may assign a formation to the assets to form a configuration of the convoy. In step 240, the user may assign a route for the convoy of assets to travel along during the mission.

In step 250 of the method 200, the assets may be tracked (e.g., tracked with respect to geographic position of each asset and/or tracked with respect to relative position between assets) during the mission. In step 260, alerts and events may be generated during the mission. For example, an alert may be generated when an asset deviates from an assigned property, formation, or route. Furthermore, an event may be generated when an asset adheres to or completes an aspect of the mission. In step 270, virtual representations of the assets, the characteristics and properties of the assets, the generated alerts or events, and the route may be displayed. In step 280, one or more reports may be generated with respect to one or more of the assets or with respect to the mission as performed by the assets.

As an example, a security company using the system of FIG. 1 may have ten target assets (e.g., armored trucks) and fifty escort assets (e.g., motorcycles) from which to choose for any particular mission. A dispatcher at the security company may use the system 100 to plan a mission by selecting one target asset and six escort assets. The dispatcher (user) can proceed to assign a formation to the seven assets to form a convoy of assets. For example, the user may select and arrange displayed icons which are representative of the assets to assign a formation. Alternatively, the user may select a pre-defined formation of assets.

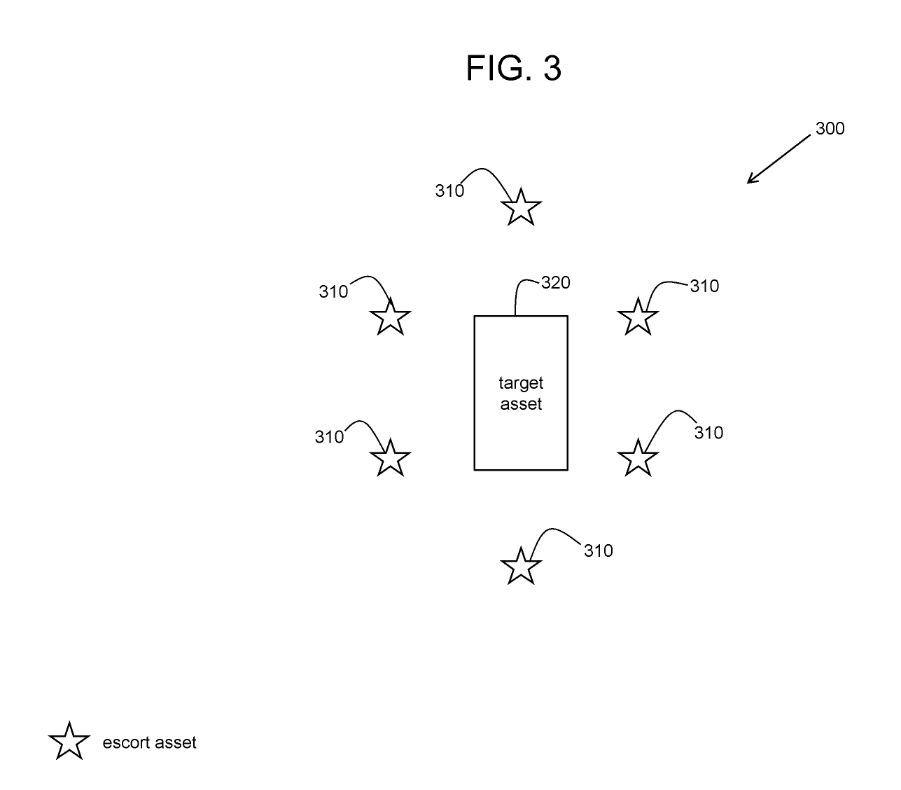

FIG. 3 illustrates an exemplary embodiment of a representation of an assigned formation 300 of escort assets 310 and a target asset 320 configured using the system 100 of FIG. 1. The target asset 320 may be an armored transport vehicle carrying a cargo of precious metal or minerals, and the escort assets 310 may be motorcycles, for example. As seen in FIG. 3, one escort asset is assigned to be in front of the target asset (i.e., a lead escort vehicle), another escort asset is assigned to be behind the target asset, and four escort assets are assigned to be beside the target asset proximate to the four corners of the target asset. In accordance with an embodiment, displayed icons of virtual representations of the assets may be color-coded, to help a user identify the particular assets, for example. Also, color-coding may be used to represent properties of the assets, assigned statuses of the assets, delays in communications from the assets, or invalid positions of the assets, for example.

The dispatcher may assign characteristics to each of the assets using the system 100 of FIG. 1 including, for example, asset type (e.g., motorcycle or armored transport vehicle), asset identification (e.g., an identification number), and asset duty (e.g., lead escort vehicle). Furthermore, the dispatcher may assign properties (e.g., parameters of protection) to each of the assets using the system 100 of FIG. 1 including, for example, a maximum allowed directional or radial distance of an asset from another asset, an allowed directional position of an asset relative to another asset in the formation, and a maximum allowed speed of an asset. Other assignable characteristics and properties may be possible as well, in accordance with various other embodiments.

As an example, four of the escort assets may be assigned to stay proximate to a corner of the target asset and stay within three meters of the target asset during the mission. Another escort asset may be assigned to trail the target asset and stay within ten meters of the target asset during the mission. The final escort asset may be assigned to lead the target asset and travel no faster than fifty-five miles per hour during the mission.

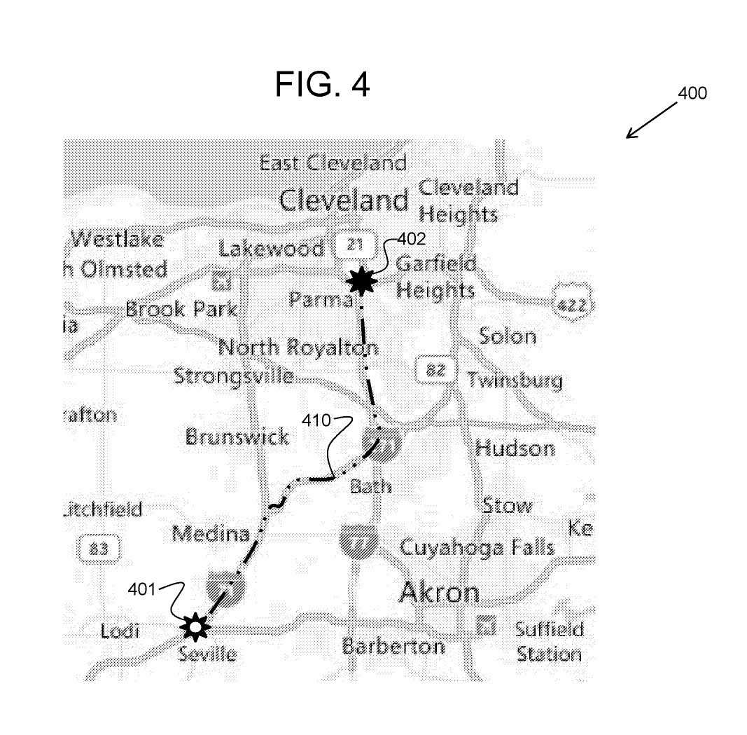

A dispatcher may next assign a route to the convoy of assets (with detailed instructions) that the convoy of assets are to follow in the assigned formation while adhering to the assigned characteristics and properties. FIG. 4 illustrates an exemplary embodiment of a screen shot of a map view 400 provided by the system 100 of FIG. 1 showing a displayed virtual representation of a route 410 (indicated by the dashed and dotted line) of a planned mission overlaid on a displayed map. The route 410 has a starting location 401 and an ending location 402. The route may be on an interstate highway system through a populated region, for example.

During the mission, the dispatcher may track the convoy of assets along the route 410 using the system of FIG. 1. Each asset may have a GPS transceiver tracking device 150 that generates GPS coordinate information from received satellite signals and relays the GPS coordinate information to the controller 110 through a data communication infrastructure 160 (e.g., a cellular telephone network and the internet).

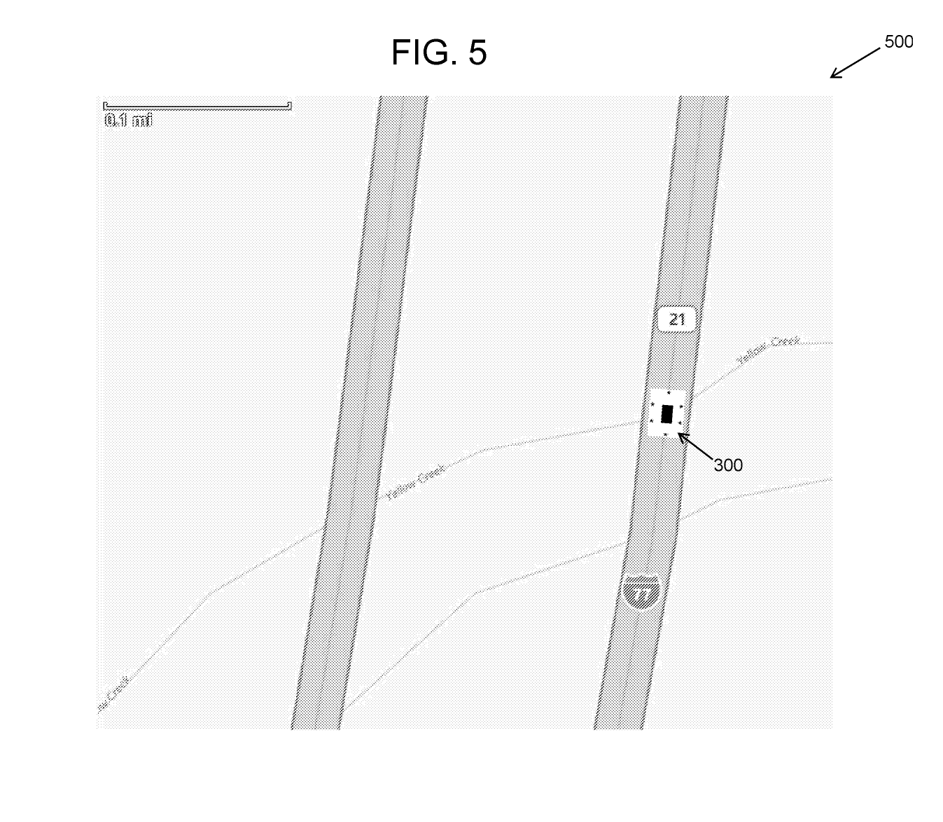

FIG. 5 illustrates an exemplary embodiment of a screen shot of a zoomed-in portion 500 of the map view 400 of FIG. 4 showing a virtual representation of the formation of assets 300 of FIG. 3 at a location along the route 410 of FIG. 4 during the mission. An icon of each asset is displayed at its actual location with respect to the map based on the GPS coordinate information. As can be seen from the portion 500 of the map view in FIG. 5, the convoy appears to be in the assigned formation going north on interstate 77 over Yellow Creek.

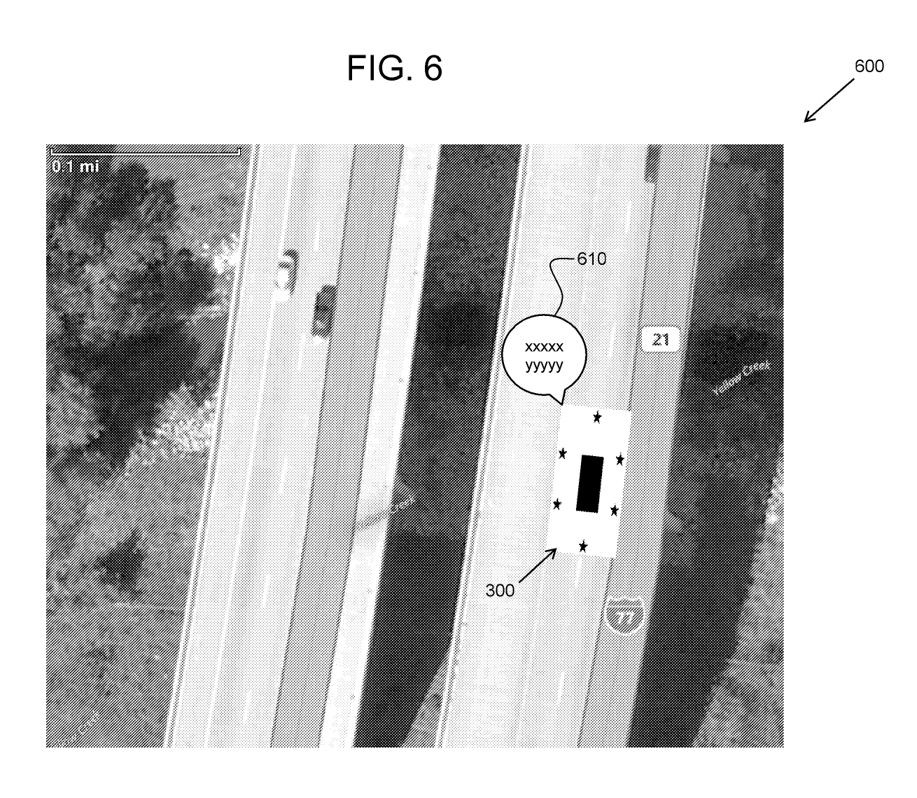

Similarly, FIG. 6 illustrates a satellite view 600 of the zoomed-in portion of FIG. 5 showing a virtual representation of the formation of assets 300 of FIG. 3 at a location along the route 410 of FIG. 4 during the mission. The satellite view may correspond to a real time view of the surrounding environment along the route, if such real time satellite information is available, or may correspond to a view of the surrounding environment along the route at some previous point in time (e.g., two months ago).

A dispatcher may employ the user device 130 to select the convoy or an asset in the convoy, causing associated information 610 to be displayed. The associated information may include GPS coordinate information, asset characteristic information, asset parameter information, asset status information, or distance between the selected escort asset and the target asset. For example, a dispatcher may use a mouse of the user interface 136 to click on the displayed leading asset. The resulting displayed associated information may show that the leading asset is currently traveling at an estimated speed of 51 miles per hour and is approximately 22 meters in front of the target asset. The controller may estimate the speed of an asset based on how its position changes with time, for example.

In accordance with an embodiment, the controller 110 is configured to compare the current state of an asset during a mission to various assignments. If an asset deviates from an assigned property, formation, or route, or if an unscheduled stop is made by the convoy, the controller 110 may generate an alert. The alert may take the form of a displayed, visual, and/or audible indicator provided by the controller and/or user device to make the dispatcher aware of the deviation or unscheduled stop.

For example, if an escort vehicle 310 falls out of formation (e.g., the trailing escort asset falls too far behind the target asset) the controller may generate an alert. In response, the dispatcher may radio the operator of the deviating escort asset and instruct the operator to come back into formation, or ask the operator if there is a problem. For example, if the trailing escort vehicle is having engine trouble and cannot keep up with the target asset, the dispatcher may instruct the remaining escort assets to assume a new formation to compensate for the troubled trailing escort vehicle. The troubled escort vehicle may then be instructed to proceed to a particular service station, for example.

A planned mission may include one or more stopping operations that are to be performed by the convoy at various points along the assigned route during the mission for the pick-up or drop-off (delivery) of goods or personnel. In accordance with an embodiment, the controller is operable to provide selectable options to a user for assigning one or more formations to the assets which the assets are to assume when the assets are performing a stopping operation. For example, the escort assets may surround the target vehicle during one stopping operation, and be behind the target vehicle during another stopping operation.

When the convoy completes a stopping operation during a mission, the controller may generate an event. In general, the controller may generate an event when an asset or the convoy adheres to or completes a defined aspect of the mission. An event may be presented to the user as a displayed, visual, and/or audible indicator provided by the controller and/or user device to make the user aware of the event. For example, the controller may determine that a convoy has very likely successfully delivered a cargo of precious minerals based on the location of the convoy and how much time the convoy spent stopped at that location. The dispatcher may radio a member of the convoy to confirm successful delivery.

When a mission is completed (whether successfully or unsuccessfully), the user may direct the controller to generate one or more reports. The reports may be with respect to one or more of the assets assigned to the mission, with respect to the route traveled by the assets, or with respect to completion of the mission or one or more aspects of the mission. For example, a user may desire to generate a summary report which summarizes the overall mission. The user may also desire to generate a report characterizing a particular stopping operation. The user may also desire to generate a report characterizing the performance of each asset during the mission. Reports may be used for training purposes, to make a mission team aware of any mistakes they made and how they can improve their performance.

In accordance with an embodiment, each report corresponds to a standard, pre-defined format with unique mission information populated into fillable data fields of the report. Specific examples of report types may include an escort vehicle report, a target vehicle report, and escort group report, and escort route report, a route incident report, and an escort stop report. Reports may be analyzed by a user (or others) to identify any weaknesses in an escort team. Furthermore, reports may allow security dispatchers to make more informed decisions for future missions, accounting for expected traffic flow and possible trouble spots.

In accordance with an embodiment, the controller is configured to plan and monitor multiple missions, where each mission is associated with a unique group of assets. One user may plan and/or monitor all of the missions from one user device. Alternatively, multiple users may each plan and/or monitor one of the missions, each using a separate user device that is in operable communication with the controller.

With reference to the drawings, like reference numerals designate identical or corresponding parts throughout the several views. However, the inclusion of like elements in different views does not mean a given embodiment necessarily includes such elements or that all embodiments of the invention include such elements.

In the specification and claims, reference will be made to a number of terms have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be”.

The terms “including” and “having” are used as the plain language equivalents of the term “comprising”; the term “in which” is equivalent to “wherein.” Moreover, the terms “first,” “second,” “third,” “upper,” “lower,” “bottom,” “top,” etc. are used merely as labels, and are not intended to impose numerical or positional requirements on their objects. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

This written description uses examples to disclose the invention, including the best mode, and also to enable one of ordinary skill in the art to practice the invention, including making and using any devices or systems and performing any incorporated methods. The embodiments described herein are examples of articles, systems, and methods having elements corresponding to the elements of the invention recited in the claims. This written description may enable those of ordinary skill in the art to make and use embodiments having alternative elements that likewise correspond to the elements of the invention recited in the claims. The scope of the invention thus includes articles, systems and methods that do not differ from the literal language of the claims, and further includes other articles, systems and methods with insubstantial differences from the literal language of the claims. While only certain features and embodiments have been illustrated and described herein, many modifications and changes may occur to one of ordinary skill in the relevant art. The appended claims cover all such modifications and changes.

What is claimed is:

1. A system for providing security escort assignment and monitoring, said system comprising a controller operable to allow a user to plan and monitor a mission by providing selectable options to a user for:
assigning escort assets to one or more target assets,
assigning characteristics and properties to the assets,
assigning a formation to the assets, and
assigning a route for the formation of the assets to travel along during the mission,
and wherein the controller is further operable to generate an alert when an asset deviates from an assigned property, formation, or route during the mission.

2. The system of claim 1, wherein the controller is further operable to generate an event when an asset adheres to or completes an aspect of the mission.

3. The system of claim 2, wherein the controller is further operable to facilitate a virtual representation of the assets, the characteristics and properties of the assets, the generated alert or event, and the route to assist the user in monitoring the assets in real time as the assets travel along the route during the mission.

4. The system of claim 3, further comprising a user device, having a display screen and a user interface, operable to communicate with the controller to allow a user to at least select the selectable options and view the virtual representations.

5. The system of claim 3, wherein the controller includes a display screen and a user interface to allow a user to at least select the selectable options and view the virtual representations.

6. The system of claim 1, further comprising one or more tracking devices associated with the assets and operable to track and report the positions of the assets to the controller in real time.

7. The system of claim 6, further comprising a data communication infrastructure operable to facilitate communication between the controller and the one or more tracking devices.

8. The system of claim 1, wherein the assigned characteristics include one or more of asset type, asset identification, and asset duty or responsibility.

9. The system of claim 1, wherein the assigned properties include one or more of a maximum allowed distance of an asset from another asset in the formation, an allowed position of an asset relative to another asset in the formation, and a maximum allowed speed of an asset.

10. The system of claim 1, wherein the planned mission includes one or more stopping operations to be performed along the assigned route for pick-up or drop-off of goods or personnel.

11. The system of claim 10, wherein the controller is further operable to provide selectable options to a user for assigning one or more formations to the assets that the assets are to assume when the assets are performing the one or more stopping operations.

12. The system of claim 1, wherein the controller is further operable to generate one or more reports with respect to one or more of the assets, with respect to the route as traveled by the assets, or with respect to completion of the mission or one or more aspects of the mission.

13. A non-transitory computer-readable medium having computer executable instructions of a software application recorded thereon, said computer-executable instructions configured to be executed by a processor of a controller to provide security escort assignment and monitoring, the instructions comprising:
instructions to provide selectable options to a user for:
assigning escort assets to one or more target assets,
assigning characteristics and properties to the assets,
assigning a formation to the assets,
assigning a route for the formation of the assets to travel along during a mission; and
instructions to facilitate the virtual representation of:
the route,
the assets on the route, and
the characteristics and properties of the assets to assist in monitoring the assets in real time as the assets travel in formation along the route during the mission.

14. The non-transitory computer-readable medium of claim 13, wherein the instructions further comprise instructions for generating an alert when an asset deviates from an assigned property, formation, or route during the mission.

15. The non-transitory computer-readable medium of claim 13, wherein the instructions further comprise instructions for generating an event when an asset adheres to or completes an aspect of the mission.

16. The non-transitory computer-readable medium of claim 13, wherein the assigned formation may be different depending on the location of the assets along the route.

17. The non-transitory computer-readable medium of claim 13, wherein the instructions further comprise instructions for generating one or more reports with respect to one or more of the assets, with respect to the route as traveled by the assets, or with respect to completion of the mission or one or more aspects of the mission.

18. A computerized method comprising:
assigning escort assets to one or more target assets;
assigning characteristics and properties to the assets;
assigning a formation to the assets; and
assigning a route for the formation of assets to travel along during a mission.

19. The method of claim 18, further comprising tracking at least a position of each of the assets during the mission.

20. The method of claim 19, further comprising generating an alert when an asset deviates from an assigned property, formation, or route during the mission.

21. The method of claim 20, further comprising generating an event when an asset adheres to or completes an aspect of the mission.

22. The method of claim 21, further comprising virtually representing and displaying the assets, the characteristics and properties of the assets, the generated alert or event, and the route to assist in monitoring the assets in real time as the assets travel along the route during the mission.

23. The method of claim 18, further comprising generating one or more reports with respect to one or more of the assets, with respect to the route as traveled by the assets, or with respect to completion of the mission or one or more aspects of the mission.
